(19) United States
(12) Patent Application Publication
(10) Pub. No.: US 2005/0149327 A1
(43) Pub. Date: Jul. 7, 2005

(54) Text messaging via phrase recognition

(75) Inventors: Daniel L. Roth, Boston, MA (US); Jordan Cohen, Gloucester, MA (US)

Correspondence Address: WILMER CUTLER PICKERING HALE AND DORR LLP, 60 STATE STREET, BOSTON, MA, 02109, US

(73) Assignee: Voice Signal Technologies, Inc., Woburm, MA (US)

(21) Appl. No.: 10/935,691

(22) Filed: Sep. 7, 2004

Related U.S. Application Data
(60) Provisional application No. 60/501,990, filed on Sep. 11, 2003.

(51) Int. Cl. G10L 15/00

(52) U.S. Cl. 704/251

(57) ABSTRACT

A method of constructing a text message on a mobile communications device, the method involving: storing a plurality of text phrases; for each of the text phrases, storing a representation that is derived from that text phrase; receiving a spoken phrase from a user; from the received spoken phrase generating an acoustic representation thereof; based on the acoustic representation, searching among the stored representations to identify a stored text phrase that best matches the spoken phrase; and inserting into an electronic document the text phrase that is identified from searching.

This application claims the benefit of U.S. Provisional Application No. 60/501,990, filed Sep. 11, 2003.

### TECHNICAL FIELD

This invention generally relates to text messaging on mobile communications devices such as cellular phones.

### BACKGROUND OF THE INVENTION

Handheld wireless communications devices (e.g., cellular phones, mobile phones, PDAs, etc.) typically provide a user interface in the form of a keypad through which the user manually enters commands and/or alphanumeric data. However, since having to manually enter input can be a dangerous distraction from other activities in which the user might be engaged, such as driving, some of these wireless devices are also equipped with speech recognition functionality. This enables the user to enter commands and responses via spoken words. In some cell phones, for example, the user can select names from an internally stored phonebook, initiate outgoing calls via, and maneuver through interface menus via voice input. This has greatly enhanced the user interface and has provided a much safer way for users to operate their phones under circumstances when their attention cannot be focused solely on the cell phone.

Another feature that has found its way into cellular phones is text messaging. This is typically provided through a service referred to as SMS (Short Message Service, which is a service for sending short text messages to mobile phones). SMS enables a user to transmit and receive short text messages at any time, independent of whether a voice call is in progress. The messages are sent as packets through a low bandwidth, out-of-band message transfer channel. Typically, the user types in the message text through the small keyboard that is provided on the device, which needless to say is a data input process that demands the complete attention of the user.

### SUMMARY OF THE INVENTION

In general, in one aspect, the invention features a method of constructing a text message on a mobile communications device. The method involves: storing a plurality of text phrases; for each of the text phrases, storing a representation that is derived from that text phrase; receiving a spoken phrase from a user; from the received spoken phrase generating an acoustic representation thereof; based on the acoustic representation, searching among the stored representations to identify a stored text phrase that best matches the spoken phrase; and inserting into an electronic document the text phrase that is identified from searching.

Other embodiments include one or more of the following features. For each of the text phrases, the derived representation that is stored is an acoustic representation of that text phrase. The method also includes, for each text phrase of the plurality of text phrases, generating an acoustic representation thereof. The method further includes, for each text phrase of the plurality of text phrases, generating a phonetic representation thereof and, for each text phrase of the plurality of text phrases, generating an acoustic representation from the phonetic representation thereof. The document is a text message. The method also involves transmitting the text message that includes the inserted text phrase via a protocol from a group consisting of SMS, MMS, instant messaging, and email. The method further involves accepting as input from the user at least some of the text phrases of the plurality of text phrases.

In general, in another aspect, the invention features a mobile communications device including: a transmitter circuit for wirelessly communicating with a remote device; an input circuit for receiving spoken input from a user; a digital processing subsystem; and a memory subsystem storing a plurality of text phrases and for each of the plurality of text phrases a corresponding representation derived therefrom, and also storing code which causes the digital processing subsystem to: generate an acoustic representation of a spoken phrase that is received by the input circuit; search among the stored representations to identify a stored text phrase that best matches the spoken phrase; and insert into an electronic document the text phrase that is identified from searching.

Other embodiments include one or more of the following features. For each of the text phrases, the derived representation that is stored in memory is an acoustic representation of that text phrase. The code in the memory subsystem also causes the digital processing subsystem to generate for each text phrase of the plurality of text phrases an acoustic representation thereof. The code also causes the digital processing subsystem to generate for each text phrase of the plurality of text phrases a phonetic representation thereof and from which the acoustic representation is derived. The electronic document is a text message. The code in the memory subsystem further causes the digital processing subsystem to transmit the text message with the inserted text phrase to the remote device via the transmitter circuit using a protocol from a group consisting of SMS, MMS, instant messaging, and email. The code in the memory subsystem also causes the digital processing subsystem to accept as input from the user at least some of the text phrases of the plurality of text phrases.

At least one or more of the embodiments has the advantage that there is no need to train the phrases. The user need only know how to pronounce them.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a block diagram of the recognition system.

FIG. 2 shows a high-level block diagram of a smartphone.

### DETAILED DESCRIPTION

The state of the art in speech recognition is capable of very high accuracy name recognition from an acoustic model, a pronunciation module, and a collection of names. One example of such an application is the speaker independent name recognition fielded in the Samsung i700 cell phone, where the acoustic model is a general English language model, the pronunciation module is a statistical model trained from the pronunciations of several million English names, and the collection of phrases is the names in the contact list of the device. In this device, any name may be selected by speaking the name, and for a list of several hundred or thousands of names error rates are in the small single digits. This functionality can be used to support phrase recognition for text entry through speech.

The described embodiment is a smartphone that implements the phrase recognition functionality to support its text messaging functions. The smartphone includes much of the standard functionality that is found on currently available cellular phones. For example, it includes the following commonly available applications: a phone book for storing user contacts, text messaging which uses SMS (Short Message Service), a browser for accessing the Internet, a general user interface that enables the user to access the functionality that is available on the phone, and a speech recognition program that enables the user to enter commands and to select names from the internal phone book through spoken input. In addition to the functionality that is commonly available in such phone-implemented speech recognition programs, the described embodiment also includes a text entry through phrase recognition feature.

To support text entry through phrase recognition feature, the phone also includes a list of “favorite” text phrases stored in internal memory. In the described embodiment, the stored list of “favorite” phrases includes the following:
“I'm on my way home”
“Meet me for lunch at the usual place”
“Call me on my office phone”
“Call me on my cell phone”
“We can talk about it tonight over dinner”

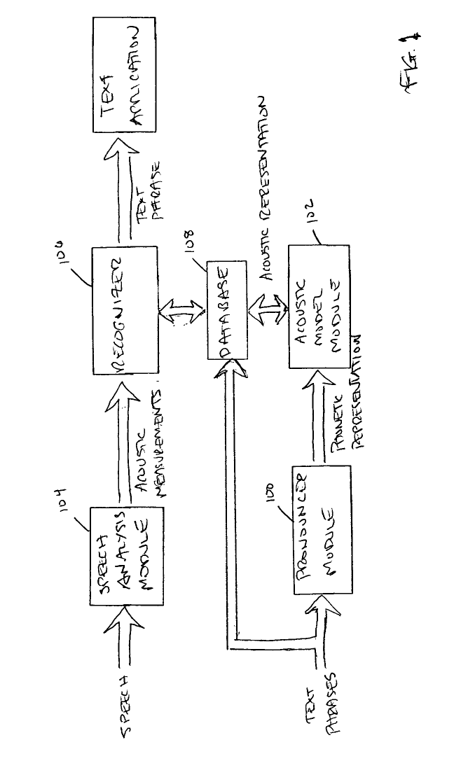

The speech recognition program that performs phrase recognition on the phone implements well-known and commonly available speech recognition functions. Referring to FIG. 1, in terms of functionality the speech recognition program includes a pronunciation module 100, an acoustic model module 102, a speech analysis module 104, and a recognizer module 106. Pronunciation module 100 and acoustic model module 102 process the set of text phrases to generate corresponding acoustic representations that are stored in an internal database 108 in association with the text phrases to which they correspond. The collection of acoustic representation of the text phrases define the search space for performing the text phrase recognition. Pronunciation module 100 is a statistically based module (or rule based module, depending on the language) that converts each text phrase (e.g. a person's name or a text phrase) to a phonetic representation of that phrase. Each phonetic representation is in the form of a sequence of phonemes; it is compact, and the conversion is very fast. For each phonetic representation, acoustic model module 102, which employs an acoustic model for the language of the speaker, produces an expected acoustic representation for that phrase. It operates in much the same way as the name recognition systems currently available today but instead of operating on names it operates on text phrases. The resulting acoustic representations are stored in the internal database for use later during the phrase recognition process.

When the user speaks a phrase into the phone, speech analysis module 104 processes the received speech to extract the relevant features for speech recognition and outputs those extracted features as acoustic measurements of the speech signal. Then, recognizer module 106 searches the database of stored acoustic representations for the various possible text phrases to identify the stored acoustic representation that best matches the acoustic measurements of the received input speech signal. To improve the efficiency of the search, the recognizer employs a phonetic tree. In essence the tree lumps together all phrases that have common beginnings. So if a search proceeds down one branch of the tree all other branches can be removed from the remaining search space.

Upon finding the best representation, recognizer module 106 outputs the text phrase corresponding to that best representation. In the described embodiment, recognizer module 106 inserts the phrase into a text message that is being constructed by the text messaging application. Recognizer module 106 could, however, insert the recognized text phrase into any document in which text phrases are relevant, though it is likely that the application that provides the most benefit from his approach would be the text messaging application that uses SMS or MMS (Multimedia Message Service, which is a store-and-forward method of transmitting graphics, video clips, sound files and short text messages over wireless networks using the WAP protocol) or instant messaging or email).

Because the search space over which the recognizer conducts its search is very constrained (i.e., it includes only the limited number of text phrases that are stored in the phone), the best match is generally found easily and the result is typically very accurate.

In the example described thus far, the user speaks the full text phrase that is desired. An alternative approach is to permit the user to speak only a portion of the desired phrase and to conduct the search through the possible text phrases to identify the best match. The search that is required in that case is more complicated than the case in which the full phrase is expected. However, the algorithms for conducting such searches are well known to persons of ordinary skill in the art.

With the acoustic representations for the text phrases in hand and with an utterance from the speaker which purports to be one of the phrases in the list (or a subpart of one of the phrases), it is also relatively straightforward to order the phrases by the likelihood that each phrase was uttered. If the user speaks the full phrase, then the most likely phrase as measured by the phrase recognition system will almost always be the phrase that the speaker uttered. If the speaker utters only part of a phrase, then the accuracy will depend upon the uniqueness of the selected portion with respect to the other phrases in the list. The result is also more likely to be that there are multiple choices among the stored text phrases that have similar probabilities of being the spoken phrase. In that case, it is a straightforward matter to present the user with an ordered list of the choices of phrases and offer the user the ability to select the correct one after-the-fact.

The text phrases that are stored in the memory can represent a preset list provided by the manufacturer. Or it can be a completely customizable list that is generated by the user who enters (by keying, downloading, or otherwise making available) his or her favorite messaging phrases. Or it can be the result of a combination of the two approaches. Also, the phrase recognition system can be (and is) much simpler than a more general speech-to-text recognizer, and it can be implemented in much smaller footprint and much less computation than a more general system. It will allow messages to be entered quickly and with an intuitive interface since the phrases are personal to the user.

Error rates in this type of system are very small, and it is possible to implement this idea in any phone or handheld device that supports (or could support) speaker independent name dialing. In fact, if speaker independent (SI) name dialing is present, then the application for this messaging system can be parasitic on the acoustic models, pronunciation modules, and recognition system used for names. Thus, any phone with SI names and a native (or added) messaging client could be modified to implement this “phrase centric” messaging client to add phrases to the list of items that can be recognized and automatically added to the text or message being generated by the client.

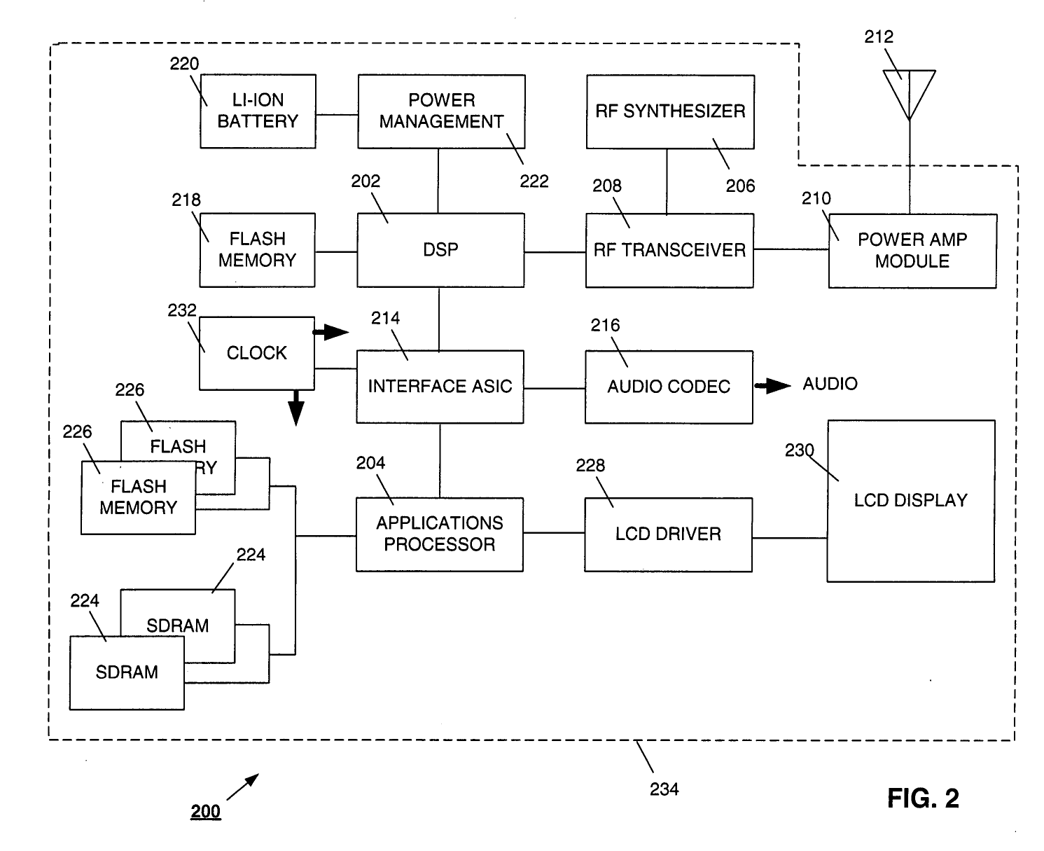

A typical platform on which such functionality can be implemented is a smartphone 200, such as is illustrated in the high-level block diagram form in FIG. 2. In this example, smartphone 200 is a Microsoft PocketPC-powered phone which includes at its core a baseband DSP 202 (digital signal processor) for handling the cellular communication functions (including for example voiceband and channel coding functions) and an applications processor 204 (e.g. Intel StrongArm SA-1110) on which the PocketPC operating system runs. The phone supports GSM voice calls, SMS (Short Messaging Service) text messaging, wireless email, and desktop-like web browsing along with more traditional PDA features.

The transmit and receive functions are implemented by an RF synthesizer 206 and an RF radio transceiver 208 followed by a power amplifier module 210 that handles the final-stage RF transmit duties through an antenna 212. An interface ASIC 214 and an audio CODEC 216 provide interfaces to a speaker, a microphone, and other input/output devices provided in the phone such as a numeric or alphanumeric keypad (not shown) for entering commands and information. DSP 202 uses a flash memory 218 for code store. A Li-Ion (lithium-ion) battery 220 powers the phone and a power management module 222 coupled to DSP 202 manages power consumption within the phone.

Volatile and non-volatile memory for applications processor 214 is provided in the form of SDRAM 224 and flash memory 226, respectively. This arrangement of memory is used to hold the code for the operating system, all relevant code for operating the phone and for supporting its various functionality, including the code for any applications software that might be included in the smartphone as well as the voice recognition code mentioned above. It also stores the data for the phonebook, the text phrases, and the acoustic representations of the text phrases.

The visual display device for the smartphone includes an LCD driver chip 228 that drives an LCD display 230. There is also a clock module 132 that provides the clock signals for the other devices within the phone and provides an indicator of real time.

All of the above-described components are packages within an appropriately designed housing 234.

Since the smartphone described above is representative of the general internal structure of a number of different commercially available phones and since the internal circuit design of those phones is generally known to persons of ordinary skill in this art, further details about the components shown in FIG. 1 and their operation are not being provided and are not necessary to understanding the invention.

The search for the best match that is described above takes places in the acoustic representation space. Alternatively, it could be done in the phonetic representation space since the two spaces are somewhat isomorphic.

Other embodiments are within the following claims.

1. A method of constructing a text message on a mobile communications device, said method comprising:
storing a plurality of text phrases;
for each of the text phrases, storing a representation that is derived from that text phrase;
receiving a spoken phrase from a user;
from the received spoken phrase generating an acoustic representation thereof;
based on the acoustic representation, searching among the stored representations to identify a stored text phrase that best matches the spoken phrase; and
inserting into an electronic document the text phrase that is identified from searching.

2. The method of claim 1, wherein for each of the text phrases, the derived representation that is stored is an acoustic representation of that text phrase.

3. The method of claim 1 further comprising for each text phrase of the plurality of text phrases generating an acoustic representation thereof.

4. The method of claim 1 further comprising for each text phrase of the plurality of text phrases generating a phonetic representation thereof.

5. The method of claim 4 further comprising for each text phrase of the plurality of text phrases generating an acoustic representation from the phonetic representation thereof.

6. The method of claim 1, wherein the document is a text message.

7. The method of claim 6 further comprising transmitting the text message that includes the inserted text phrase via a protocol from a group consisting of SMS, MMS, instant messaging, and email.

8. The method of claim 6 further comprising transmitting the text message that includes the inserted text phrase via SMS.

9. The method of claim 1 further comprising accepting as input from the user at least some of the text phrases of the plurality of text phrases.

10. A mobile communications device comprising:
a transmitter circuit for wirelessly communicating with a remote device;
an input circuit for receiving spoken input from a user;
a digital processing subsystem; and
a memory subsystem storing a plurality of text phrases and for each of the plurality of text phrases a corresponding representation derived therefrom, and also storing code which causes the digital processing subsystem to:
generate an acoustic representation of a spoken phrase that is received by the input circuit;
search among the stored representations to identify a stored text phrase that best matches the spoken phrase; and
insert into an electronic document the text phrase that is identified from searching.

11. The mobile communication device of claim 10, wherein for each of the text phrases, the derived representation that is stored in memory is an acoustic representation of that text phrase.

12. The mobile communication device of claim 10, wherein the code in the memory subsystem also causes the digital processing subsystem to generate for each text phrase of the plurality of text phrases an acoustic representation thereof.

13. The mobile communication device of claim 10, wherein the code in the memory subsystem also causes the digital processing subsystem to generate for each text phrase of the plurality of text phrases a phonetic representation thereof.

14. The mobile communication device of claim 13, wherein the code in the memory subsystem also causes the digital processing subsystem to generate for each text phrase of the plurality of text phrases an acoustic representation from the phonetic representation thereof.

15. The mobile communication device of claim 10, wherein the electronic document is a text message.

16. The mobile communication device of claim 15 wherein the code in the memory subsystem also causes the digital processing subsystem to transmit the text message with the inserted text phrase to the remote device via the transmitter circuit.

17. The mobile communication device of claim 15 wherein the code in the memory subsystem also causes the digital processing subsystem to transmit the text message with the inserted text phrase to the remote device through the transmitter circuit via a protocol from a group consisting of SMS, MMS, instant messaging, and email.

18. The mobile communication device of claim 15 wherein the code in the memory subsystem also causes the digital processing subsystem to transmit the text message with the inserted text phrase to the remote device through the transmitter circuit via SMS.

19. The mobile communication device of claim 10, wherein the code in the memory subsystem also causes the digital processing subsystem to accept as input from the user at least some of the text phrases of the plurality of text phrases.
